(19) United States
(12) Patent Application Publication
(10) Pub. No.: US 2014/0015395 A1
(43) Pub. Date: Jan. 16, 2014

(54) REFRIGERATOR WITH PLATFORM FOR IMPROVED FOAM DISCHARGE

(71) Applicants: JON MICHAEL ANTHONY, Evansville, IN (US); BURL DAVID BREDENKAMP, Marengo, IA (US); DEREK THOMAS LEHMAN, Coralville, IA (US); RON S. PAULSEN, Marengo, IA (US)

(72) Inventors: JON MICHAEL ANTHONY, Evansville, IN (US); BURL DAVID BREDENKAMP, Marengo, IA (US); DEREK THOMAS LEHMAN, Coralville, IA (US); RON S. PAULSEN, Marengo, IA (US)

(73) Assignee: WHIRLPOOL CORPORATION, BENTON HARBOR, MI (US)

(21) Appl. No.: 13/547,375

(22) Filed: Jul. 12, 2012

(51) Int. Cl. F25D 23/06; B23P 11/00

(52) U.S. Cl. 312/406; 29/428

(57) ABSTRACT

A refrigerator includes a cabinet composed of a top, bottom, right, left, and back wall forming an interior space. There is at least one opening or pour hole in a cabinet wall. There is an insulating panel positioned in the interior space of the cabinet adjacent to at least one wall. There is a platform or bridge that extends from the at least one pour hole to the at least one insulating panel, such that the platform is at least as thick at the top edge as the adjacent portion of the at least one insulating panel. There is foam discharged through the at least one pour hole, the foam passing adjacent to the platform, and adjacent to the at least one insulating panel.

### BACKGROUND OF THE INVENTION

1. Field of the Invention

The present invention relates to refrigerators, more particularly, the present invention relates to refrigerators having a platform or bridge on an interior wall of the refrigerator cabinet adjacent to a pour hole, the platform improving flow of foam into the interior of the cabinet through the pour hole .

### SUMMARY OF THE INVENTION

Refrigerators may contain vacuum insulated panels. An example of such a refrigerator is disclosed in U.S. Pat. No. 5,082,335, herein incorporated by reference. Vacuum insulated panels are used because of their superior insulation characteristics.

Refrigerators also may contain foam insulation. Examples of such refrigerators are disclosed in U.S. Pat. No. 3,989,328, U.S. Pat. No. 5,655,351, and U.S. Pat. No. 6,036,293, all of which are herein incorporated by reference. Foam insulation is used because of its ability to fill in and insulate adverse geometries. Foam insulation is injected while hot and semi-liquidous. Foam insulation may be injected though one or more pour holes into the cavity between the outer cabinet and the inner liner or liners. The foam expands to fill this void, and cools to create an insulated, solidified wall. During injection the foam has a tendency to fan out and expand, and does not maintain a steady flow stream. In addition, the foam tends to catch on obstructions, such as air ducts, liner sumps, and wire harnesses, and will tend to pool around the obstructions.

Air ducts running to an icemaker may extend down along the interior back wall of the outer cabinet. As a result the rear exterior wall of the refrigerator may experience condensation if the surrounding insulation is insufficient to insulate against the temperature differential.

There are tradeoffs between the use of vacuum insulated panels and foam insulation, and for this reason refrigerators may use varying degrees each material, as in U.S. Pat. No. 5,082,335. Where possible, a combination of foam insulation and vacuum insulated panels may be used to increase insulation value while not exceeding spatial constraints. If such a combination is possible, a lip is created as a result of the added thickness of the vacuum insulated panel. This lip will act as an obstruction to the flow of foam during injection.

The invention concerns a refrigerating compartment, comprising: (1) a cabinet having a plurality of walls forming an interior space, (2) at least one opening in a wall of the cabinet, (3) an insulating panel positioned in the interior of the cabinet, (4) a bridge or platform extending from the insulating panel to the at least one opening in the wall of the cabinet, and (5) the discharge of foam through the opening in the wall of the cabinet.

It is a primary object, feature, or advantage of the present invention to improve over the state of the art.

It is a further object, feature, or advantage of the present invention to use a foam bridge in conjunction with a vacuum insulated panel to improve flow characteristics during injection of the foam into the space between the outer cabinet and the inner liner or liners.

According to one aspect of the present invention, a refrigerator is provided. The refrigerator includes an outer cabinet. There is a vacuum insulated panel situated against the interior back wall of the outer cabinet. There is at least one pour hole situated along the back edge of the bottom wall of the outer cabinet. There is a foam bridge situated against the interior back wall and extending from the pour hole to the bottom of the vacuum insulated panel.

According to another aspect of the present invention, a method of using a refrigerator is provided. The method includes providing the refrigerator, the refrigerator including (a) an outer cabinet, (b) a vacuum insulated panel, (c) at least one pour hole, and (d) a foam bridge. The method further includes injecting foam through the pour hole without obstruction by the vacuum insulated panel.

### BRIEF DESCRIPTION OF THE DRAWINGS

FIG. 1 is a perspective view of the back side of a refrigerator with the rear wall removed;

FIG. 2 is a cutout view of a refrigerator along the centerline of a foam platform or bridge;

FIG. 3 is an exploded view of a refrigerator including an insulating panel and a foam platform or bridge;

FIG. 4 is an angled perspective view of a foam platform or bridge;

FIG. 5 is a front perspective view of a foam platform or bridge;

FIG. 6 is a side perspective view of a foam platform or bridge.

### DETAILED DESCRIPTION OF THE PREFERRED EMBODIMENTS

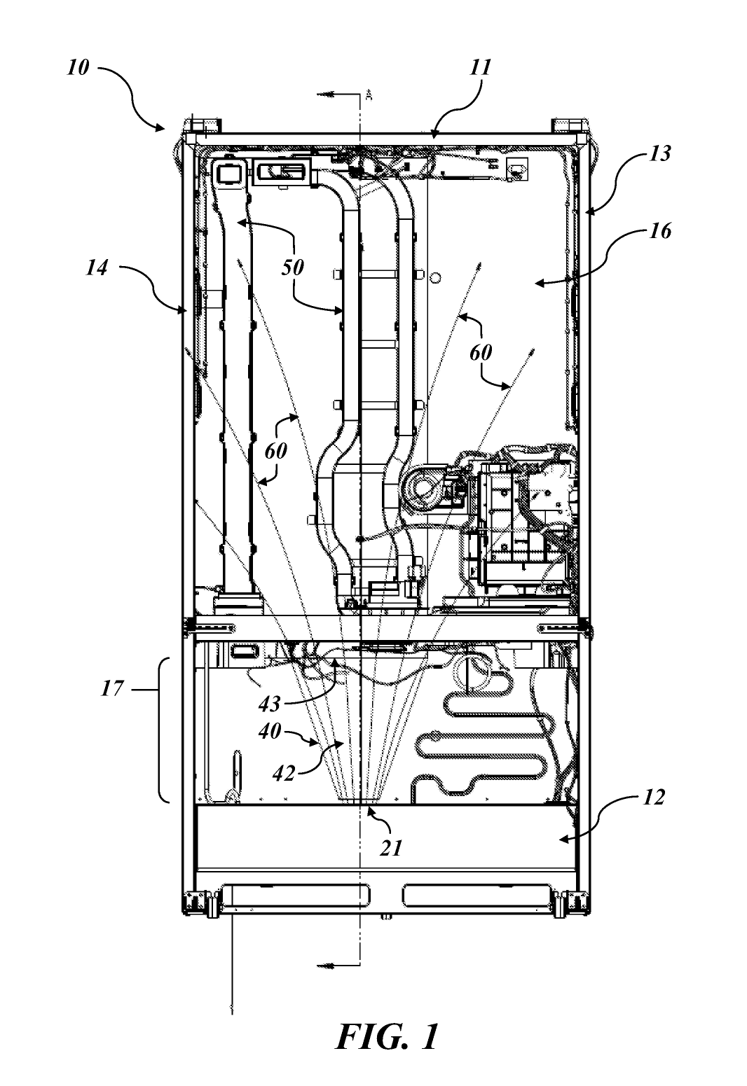

The present invention provides for a refrigerator which is configured to use a foam bridge to improve injection of insulation into the refrigerator. FIG. 1 contains an enclosure or cabinet 10 with top 11, bottom 12, left 13, right 14, and back 15 walls. Together the walls form an interior space 16. There is at least one opening or pour hole 21 in a wall of the cabinet 10. The at least one opening may be located in any wall of the cabinet, including the top, bottom, left, right, or back wall. In the preferred embodiment the pour hole 21 is positioned in the bottom wall 12 adjacent to the back wall 15. At least one air supply duct 50 runs adjacent to the back wall 15, and supplies low temperature air to the icemaker (not shown). Because of the proximity of the air supply ducts 50 to the back wall 15, condensation or sweating may occur on the exterior surface of the back wall 15. In addition, low temperature air traveling through the air supply ducts 50 may be adversely affected by a lower insulation value. Also shown in FIG. 1 are approximate flow lines 60 showing the estimated discharge pattern of foam during injection. The foam flows through the pour hole 21, across the platform 40 or bridge, and subsequently across the insulating panel 30. The platform 40 may take any shape that serves to bridge the gap 17 between the pour hole 21 and the bottom edge 34 of the insulating panel 30.

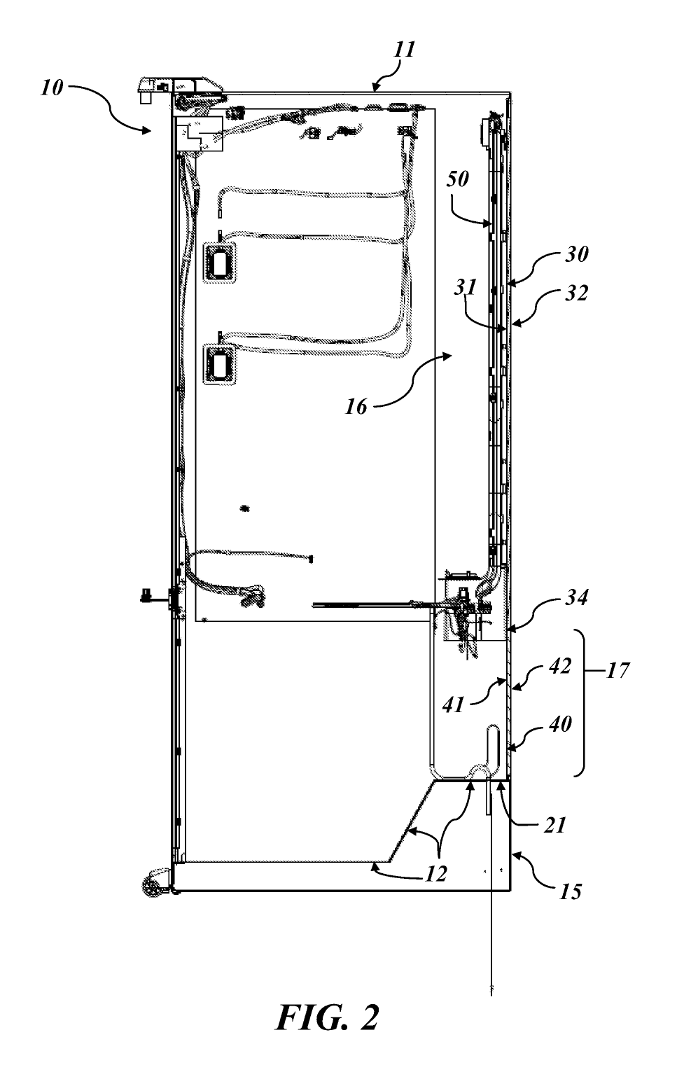

FIG. 2 contains a cutout of the cabinet 10 along the centerline 44 of the platform 40. An interior space 16 is created between top 11, bottom 12, and back 15 walls. The pour hole 21 is located in the bottom wall 12, adjacent to the back wall 15. An insulating panel 30, having a front wall 31, a rear wall 32, and an edge 33, is positioned in the interior space 16, such that the rear wall 32 is adjacent to the back wall 15 of the cabinet 10. At least one air supply duct 50 is located adjacent to the back wall 15 of the cabinet 10, but is spaced such that the insulating panel 30 is interposed between the air supply duct 50 and the back wall 15. The placement of the insulating panel 30 between the air supply duct 50 and the back wall 15 of the cabinet 10 provides a solution for the condensation or sweating that may occur on the exterior of the back wall 15. Placement of the insulating panel 30 adjacent to the back wall 15 creates a lip having a thickness represented by the edge 33 of the insulating panel 30. Upon discharged through the pour hole 21, entering foam tends to fan out and tumble, and will stop when it hits obstructions such as the lip created by the lower portion 34 of the edge 33 of the insulating panel 30. As a result of this obstruction, foam pooling occurs near the lower portion 34 of the edge 33. Once the foam has expanded and cooled the interior space 16 may not be completely filled by the expanded foam, and may leave voids.

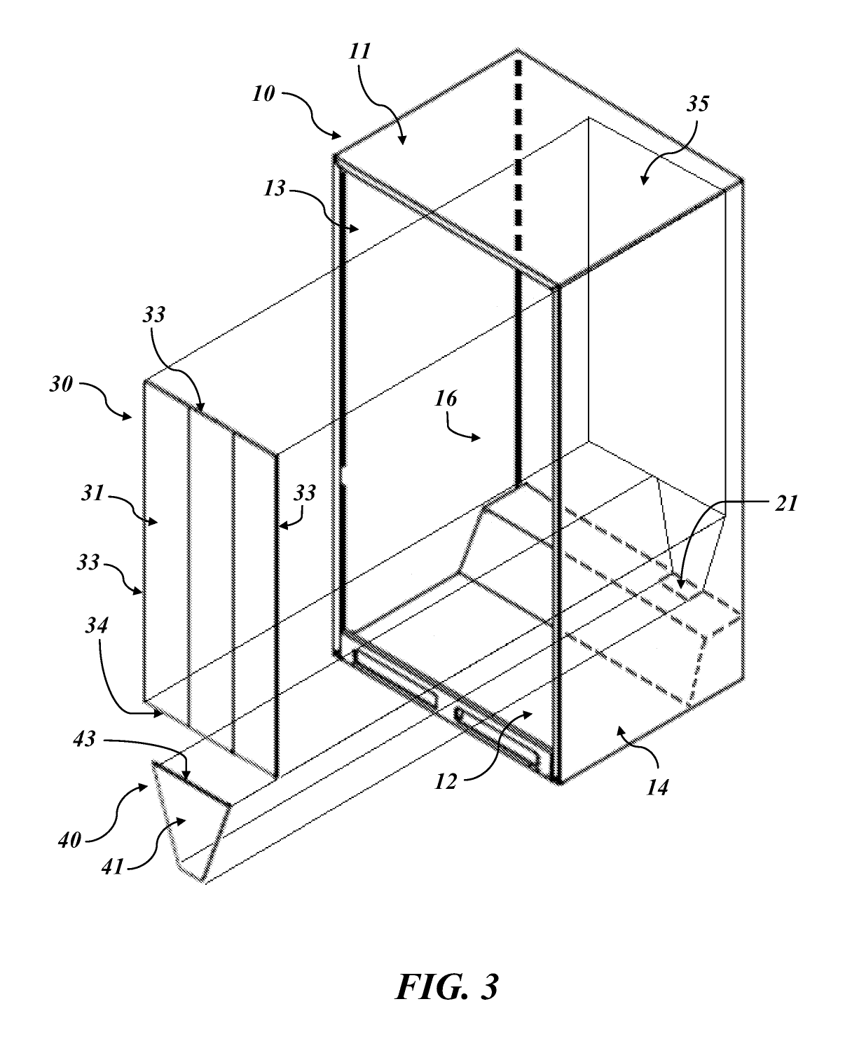

In the preferred embodiment the gap 17 between the pour hole 21 and the lower portion 34 of the edge 33 of the insulating panel 30 is bridged or filled by the platform 40 or bridge. In FIG. 2 a platform 40, having a front wall 41, a rear wall 42, and at least a top edge 43, is located adjacent to the back wall 15 of the cabinet 10, and fits between the pour hole 21 and the lower portion 34 of the edge 33 of the insulating panel 30. The platform covers the gap 17 and allows discharged foam to flow into the interior space 16 without obstruction against the lower portion 34 of the edge 33. In FIG. 3 an exploded view shows the approximate arrangement of the insulating panel 30 and the platform 40 in the interior space 16 adjacent to the back wall 15. The insulating panel 30 should be large enough to cover at least one air supply duct 50 and fit interposed between the air supply duct 50 and the back wall 15. The insulating panel may be rectangular or various other shapes, such as, but not limited to the following: circular, triangular, rhomboid, etc. In the preferred embodiment the insulating panel is a rectangular, vacuum insulated panel, and is large enough to cover all air supply ducts 50 running adjacent to the back wall 15 of the cabinet 10. The platform 40 or bridge may be any shape that serves to bridge the gap 17 between the pour hole 21 and the lower portion 34 of the edge 33 of the insulating panel 30. The platform 40 or bridge may be semi-circular, rectangular, or various other symmetric or non-symmetric shapes. In the preferred embodiment the platform 40 is shaped trapezoidially, and is symmetric about a centerline 44. Various shapes and geometries may be used and are expressly included within this patent application. In the preferred embodiment the platform 40 is oriented such that the base of the trapezoidal shape constitutes the top edge 43 of the platform 40. The top edge 43 is aligned with the bottom portion 34 of the edge 33 of the insulating panel 30, and the platform 40 extends all the way down to the pour hole 21.

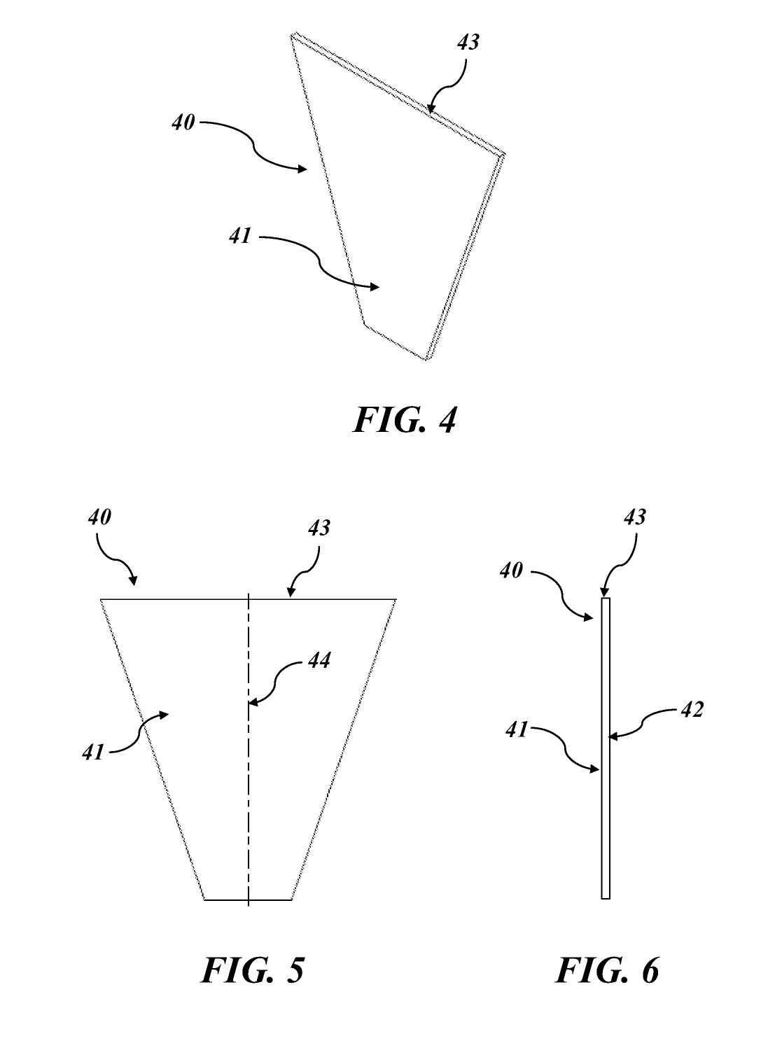

FIG. 4 shows a platform 40 of a trapezoidal shape, having a front wall 41, and a top edge 43 of a thickness no less than the thickness of the bottom portion 34 of the edge 33 of the insulating panel 30. FIG. 5 shows a platform 40 having a front wall 41 and a top edge 43, and being configured such that the trapezoidal shape is symmetric about a centerline 44. FIG. 6 shows a side view of the trapezoidal platform 40, having a front wall 41, a back wall 42, and a top edge 43 at least as thick as the thickness of the lower portion 34 of the edge 33 of the insulating panel 30. While a platform 40 or bridge of substantially uniform thickness is the preferred embodiment for this invention, other geometries may be used. For example the platform 40 may be tapered such that it is thinner on one side then on the other, or the platform 40 may be wedge or ramp shaped such that the maximum thickness is at least as thick as the lower portion 34 of the edge 33 of the insulating panel 30. The platform, further, may have a varying thickness that does not change symmetrically from one side to the other, such as a thickness variation resembling an exponential decay. The variance in thickness may also be two-dimensional, such that more geometries are possible, for example a half-disc shaped platform may be achieved. The shape of the platform 40 may also resemble any fan shape, or another shape with a spreading pattern.

In another embodiment the platform 40 and the insulating panel 30 may be combined. In this embodiment the platform 40 begins at the pour hole 21 and extends upward as one uniform panel. The platform 40 in this embodiment may take on many shapes and geometries, and may be rectangular, triangular, triangular with an arc on one or more sides, abstract, and various other shapes. In this embodiment the seam between the top edge 43 of the platform 40 and the lower portion 34 of the edge 33 of the insulating panel 30 is eliminated. The platform 40 may be composed of any insulating material, and may be expanded polystyrene. In addition the platform 40 may be layered with another smoother material on the front wall. This smoother material may be polyethylene. The platform 40 may also be a vacuum insulated panel.

The invention claimed is:

1. A refrigerating compartment, comprising:
an enclosure having at least a top, bottom, left, right and back wall, and forming an interior space;
at least one opening in the bottom wall positioned adjacent to the back wall of the enclosure;
at least one insulating panel having a front wall, a rear wall, and an edge running around the perimeter of the insulating panel, said edge having a bottom portion, said at least one insulating panel positioned in the interior space of said enclosure, and said rear wall of the at least one insulating panel being adjacent to the back wall of the enclosure;
a platform having a front wall, a rear wall, and at least a top edge, positioned in the interior space of the enclosure, said platform rear wall being adjacent to the enclosure back wall, said platform top edge being adjacent to said bottom portion of the at least one insulating panel edge, said platform top edge being at least as thick as said bottom portion of the at least one insulating panel edge, and said platform extending from said bottom portion of the at least one insulating panel edge to the at least one opening in the bottom wall of the enclosure;
wherein foam may be discharged through the at least one opening in the bottom wall, with the foam passing adjacent to the platform, and adjacent to the at least one insulating panel.

2. The refrigerating compartment of claim 1 wherein the insulating panel is substantially rectangular.

3. The refrigerating compartment of claim 1 wherein the insulating panel is of a substantially uniform thickness.

4. The refrigerating compartment of claim 1 wherein the at least one insulating panel is substantially interposed between at least one air supply duct located adjacent to the rear wall of the enclosure.

5. The refrigerating compartment of claim 1 wherein the at least one insulating panel is affixed to the cabinet with an adhesive.

6. The refrigerating compartment of claim 1 wherein the at least one insulating panel is a vacuum insulated panel.

7. The refrigerating compartment of claim 1 wherein the platform is of a substantially uniform thickness.

8. The refrigerating compartment of claim 1 wherein the platform is affixed to the enclosure with an adhesive.

9. The refrigerating compartment of claim 1 wherein the platform top edge thickness is greater than the thickness of the bottom portion of the at least one insulating panel edge.

10. The refrigerating compartment of claim 1 wherein the platform is expanded polystyrene.

11. The refrigerating compartment of claim 1 wherein the platform is trapezoidal in shape.

12. The refrigerating compartment of claim 11 wherein the platform is oriented such that the base of the trapezoidal shape constitutes the top edge of the platform.

13. The refrigerating compartment of claim 1 wherein the platform front wall has an additional smooth layer.

14. The refrigerating compartment of claim 13 wherein the additional smooth layer is a material such as polyethylene.

15. The refrigerating compartment of claim 13 wherein the platform and additional layer are at least as thick as said bottom portion of the at least one insulating panel edge.

16. The refrigerating compartment of claim 1 wherein only one opening is present in the enclosure.

17. The refrigerating compartment of claim 1 wherein the foam bridge enables foam pooling to occur near the top wall of the cabinet.

18. A refrigerating compartment, comprising:
a cabinet having a plurality of walls forming an interior space;
at least one pour hole situated in a wall of the cabinet;
a foam bridge positioned in the interior space of the cabinet, said foam bridge being located adjacent to the pour hole and extending away from the pour hole along the wall of the cabinet;
wherein foam may be discharged through the at least one pour hole, with the foam passing along the foam bridge.

19. The refrigerating compartment of claim 18 wherein the refrigerating compartment includes at least one insulating panel positioned in the interior space of the cabinet adjacent to the back wall of the cabinet, the at least one insulating panel being positioned so that the foam bridge is substantially interposed between the at least one pour hole and the at least one insulating panel.

20. A method of manufacturing a refrigerator, comprising:
providing the refrigerator, the refrigerator comprising (a) an enclosure having at least a top, bottom, left, right and back wall, and forming an interior space, (b) at least one opening in a wall of the enclosure, (c) at least one insulating panel positioned in the interior space, and (d) a platform positioned in the interior space so that it is substantially interposed between the at least one pour hole and the at least one insulating panel;
discharging foam through the at least one opening in the wall of the enclosure, said foam passing adjacent to the platform, and adjacent to the at least one insulating panel.
wherein the enclosure is oriented such that the back wall of the enclosure is substantially horizontal.
